(19) United States
(12) Patent Application Publication
(10) Pub. No.: US 2004/0043673 A1
(43) Pub. Date: Mar. 4, 2004

(54) Connector and substrate for eletronic circuit fabrication

(76) Inventor: Chul Park, KyongKiDo (KR)

Correspondence Address: Synnestvedt & Lechner, Aramark Tower Suite 2600, 1101 Market Street, Philadelphia, PA, 19107, US

(21) Appl. No.: 10/296,768

(22) PCT Filed: Jun. 11, 2001
(86) PCT No.: PCT/KR01/00994

(30) Foreign Application Priority Data
Jun. 14, 2000 (KR) 2000-32832
Apr. 23, 2001 (KR) 2000-21879

(51) Int. Cl. H01R 4/48; H01R 11/03

(52) U.S. Cl. 439/786

(57) ABSTRACT

An electronic circuit fabrication system in which an electronic connector and board is included. Using this electronic connector and board, the electronic circuit is fabricated without soldering. An electronic connector made of a thin metal sheet, which has multiple holes for the wire insertion of electronic parts that have a bent part to insert into the hole of a plastic board, is included. Along the bent part, there are prominent parts to fix the connector in the hole in the plastic board. The board for the insertion of an electronic connector, which has multiple holes with an extruded part in each hole on which to fix the electronic connector, is included.

### BACKGROUND OF THE INVENTION

This invention relates to a connector and a board for fabricating an electronic circuit, specifically to a connector and a board for easy fabrication of electronic circuits by inserting electronic devices into the board and making electrical connections with each other.

### RELATED ART

An electronic circuit is a combination of electronic devices such as resistors, capacitors or IC chips which are connected for certain purposes. It can work as power is supplied. In the conventional way of mass production of electronic circuits, methods of placing electronic devices on a board with copper circuit patterns and connecting the devices electrically by way of a soldering process, are widely used. If electronic circuits are not intended for mass production, but for a test or one's taste, an all-round PCB(printed circuit board) can be used.

A conventional way of making electronic circuit for test is as follows. In FIG. 1, a structure of the conventional all-round PCB is shown. Although there may be some structural differences between similar boards, the basic mechanisms of the boards are all the same. As shown in FIG. 1, an all-round PCB(1) has multiple holes(2) which are positioned periodically in it and a thin copper plate(3) which is fixed around the holes. Distances between the holes are determined according to the standardized distance of electronic device's leads. The thin copper plate(3) will be used when soldering electronic wires to connect or fix them on the board. The thin copper plate may be attached to both faces or to the lower face of the board.

In FIG. 2, widely used devices, such as semiconductor devices(11), capacitors(13) new electric connectors, which have already been connected electrically and can be easily converted into an electronic circuit. Thus, the soldering process is not required when the electric connector of this invention is used.

In carrying out the invention and according to one aspect thereof, there is provided an electric connector for making electronic circuits comprising; a plurality of electric connector main bodies; and an electric connector linking part positioned between said electric connector main bodies for electrically connecting said electric connector main bodies, wherein each electric connector main body including; a wire insertion hole for inserting a lead wire of an electronic component, a plate-shaped upper surface integrating said wire insertion hole, side surface supporting parts integrally linked to the sides of said upper surface and elongated downward and compressing said lead wire from sides when said lead wire is inserted into the wire insertion hole so as to connect said lead wire electrically to the electric connector linking part, and an electric connector fixing part formed on a lower section of said side surface supporting part for supporting the electric connector main body if inserted into a board.

Furthermore, the electric connector linking part is electrically conductive to said side surface supporting parts and takes the form of a notch having a width narrower than that of said upper surface so as to be easily bent or cut, and lead wires of the electronic components inserted into different wire insertion holes of different electric connector main bodies are electrically disconnected or connected with one another depending on the condition that the electric connector linking parts between said electric connector main bodies are cut or linked, so as that the electronic components inserted into the board can form an electronic circuit without soldering.

There is also provided a board for making electronic circuits comprising; a plurality of electric connector insertion holes, each of which having symmetrical upper and lower sections and in the middle of which a step being protruded inward for fixing the electric connector fixing part protruded in a horizontal direction.

### BRIEF DESCRIPTION OF THE DRAWINGS

The above object, features and advantages of the present invention will become more apparent from the following detailed description when taken in conjunction with the accompanying drawings, in which:

FIG. 1 is a view illustrating a structure of a conventional universal PCB;

FIG. 2 is a view exemplifying parts used for fabrication of circuits;

FIG. 3 is a view exemplifying fabrication of an electric circuit by using the conventional universal PCB;

FIG. 4 is a view illustrating a connection of lead wires on a lower surface of the conventional universal PCB;

FIG. 5 is a view illustrating a conventional bread board;

FIG. 6 is a view exemplifying fabrication of an electric circuit by using the conventional bread board;

FIG. 7 is a perspective view of an electric connector according to the present invention;

FIG. 8 is a front-plan view of the electric connector according to the present invention;

FIG. 9 is a side view of the electric connector according to the present invention;

FIG. 10 is a top-plan view of the electric connector according to the present invention;

FIG. 11 is a bottom-plan view of the electric connector according to the present invention;

FIG. 12 is a view illustrating a process of fabricating the electric connectors according to the present invention;

FIG. 13 is a view illustrating bending and separation of the electric connectors according to the present invention;

FIG. 14 is a view illustrating an insertion of a lead wire into the electric connector according to the present invention;

FIG. 15 is a top-plan view of a board according to the present invention;

FIG. 16 is a cross-sectional view of the board according to the present invention;

FIG. 17 is a bottom-plan view of the board according to the present invention;

FIG. 18 is a perspective view of the board according to the present invention;

FIG. 19 is a cross-sectional view illustrating an insertion of the electric connectors into the board according to the present invention;

FIG. 20 is a view illustrating a process of inserting the electric connectors into the board according to the present invention;

FIG. 21 is a cross-sectional view illustrating a complete insertion of the electric connectors into the board according to the present invention;

FIG. 22 is a top-plan view illustrating an inserted layout of the electric connectors into the board according to the present invention;

FIG. 23 is a cross-sectional view illustrating an insertion in FIG. 22 according to the present invention;

FIG. 24 is a view illustrating an insertion of the electric components into the board having the electric connectors inserted thereto according to the present invention;

FIG. 25 is a cross-sectional view illustrating an insertion of the electric components according to the present invention;

FIG. 26 is a view illustrating a fixation of the electric components and electric connectors according to the present invention;

FIG. 27 is a perspective view of the electric connectors illustrating a structure of opened lower surfaces;

FIG. 28 is a front-plan view illustrating a structure in FIG. 27 according to the present invention;

FIG. 29 is a diagram illustrating a process of inserting a lead wire into the electric connectors in FIG. 27;

FIG. 30 is a perspective view of the electric connectors illustrating a structure having a horizontally bent portion as a fixing part of the electric connector according to the present invention;

FIG. 31 is a perspective view of the electric connectors illustrating protruded fixing parts protruded at both sides thereof according to the present invention;

FIG. 32 is a top-plan view of the electric connectors in FIG. 31 according to the present invention;

FIG. 33 is a bottom-plan view of the electric connectors in FIG. 31 according to the present invention;

FIG. 34 is a front-plan view of the electric connectors in FIG. 31 according to the present invention;

FIG. 35 is a side view of the electric connectors in FIG. 31 according to the present invention;

FIG. 36 is a perspective view of the electric connectors having a dually bent fixing section according to the present invention;

FIG. 37 is a front-plan view in FIG. 36;

FIG. 38 is a perspective view of the electric connector having an outwardly bent fixing section according to the present invention;

FIG. 39 is a front-plan view in FIG. 38;

FIG. 40 is a side view in FIG. 38;

FIG. 41 is a view illustrating a process of inserting an electric connector according to the present invention;

FIG. 42 is a perspective view of the electric connectors in cylindrical shape according to the present invention;

FIG. 43 is an analytic view of the electric connectors in FIG. 42;

FIG. 44 is a cross-sectional view of the electric connectors illustrating upper parts thereof, to which plastic plates have been attached, according to the present invention;

FIG. 45 is a view illustrating a fabrication of the electric connectors having plastic exterior according to the present invention;

FIG. 46 is a perspective view of the electric connectors illustrating a structure thereof according to the fabrication in FIG. 45;

FIG. 47 is a top-plan view of a board having holes of a circular shape for receiving the electric connectors according to the present invention;

FIG. 48 is a bottom-plan view of the board having holes of a circular shape for receiving the electric connectors according to the present invention;

FIG. 49 is a cross-sectional view of the board in FIG. 47;

FIG. 50 is a cross-sectional view of the board having holes with protrusions in the middle thereof as steps for receiving the electric connectors according to the present invention;

FIG. 51 is a top-plan view of the board having holes with protrusions in the middle thereof as steps for receiving the electric connectors according to the present invention;

FIG. 52 is a cross-sectional view of the board in FIG. 50, into which the electric connectors have been inserted;

FIG. 53 is a cross-sectional view of the board illustrating a case of inserting a lead wire after inserting the electric connector;

FIG. 54 is a cross-sectional view of the board having slanted protrusions as steps thereof according to the present invention;

FIG. 55 is a top-plan view of the board having slanted protrusions as steps thereof according to the present invention;

FIG. 56 is a view illustrating a process of inserting the electric connectors into the board having slanted protrusions as steps thereof according to the present invention;

5 FIG. 57 is a perspective view of an elastic polymer board according to the present invention;

FIG. 58 is a front-sectional view illustrating a process of inserting and fixing the electric connectors into the elastic polymer board;

FIG. 59 is a side-sectional view illustrating a process of inserting and fixing the electric connectors into the elastic polymer board;

FIG. 60 is a top-plan view illustrating an alignment and insertion of the electric connectors into the elastic polymer board;

FIG. 61 is a view illustrating an insertion of electronic parts into the electric connectors, which have been inserted and fixed onto the elastic polymer board;

FIG. 62 is a perspective view of a board of a dual structure according to the present invention; and

FIG. 63 is a side-sectional view of the board of a dual structure, onto which the electric connectors have been inserted and fixed.

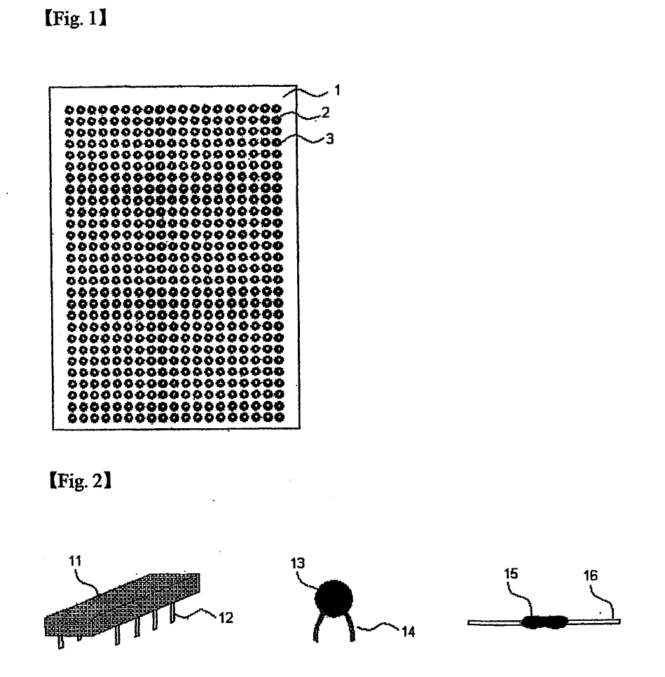

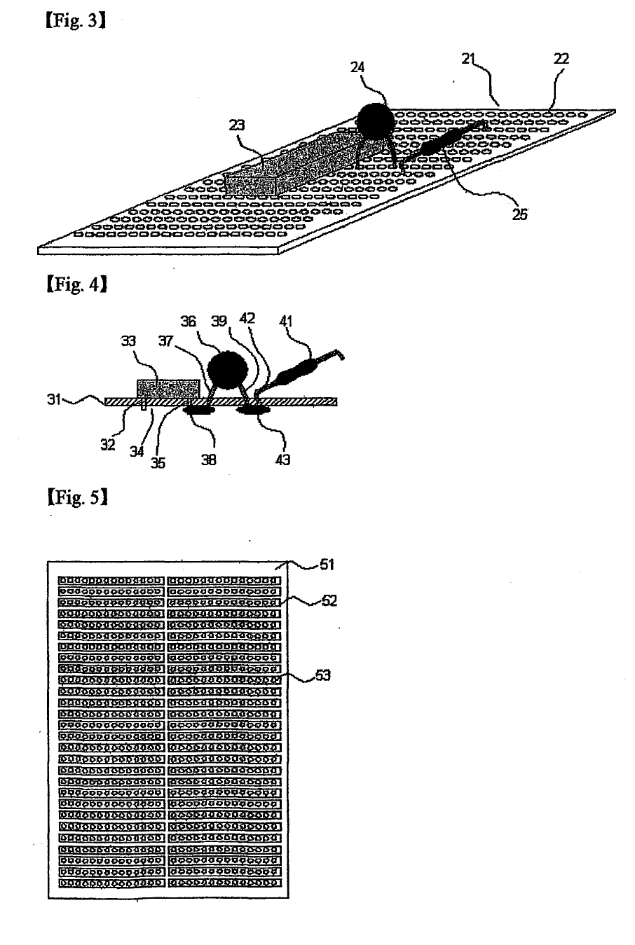

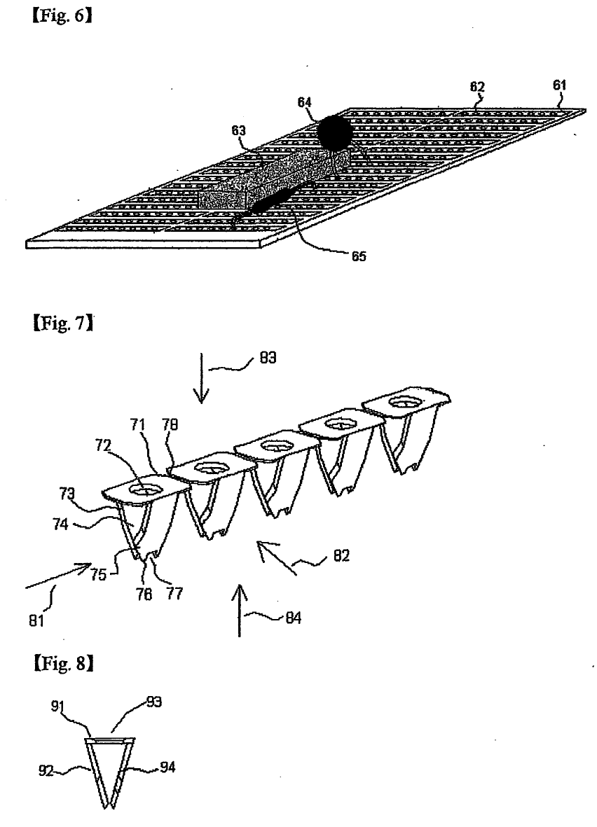

### DESCRIPTION OF THE PREFERRED EMBODIMENTS

Various embodiments for carrying out the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 7 is a perspective view of an electric connector according to the present invention. The electric connector in FIG. 7 exemplifies a case of shaping thin metal film by means of press or etching and bending it by means of press.

The electric connector according to the present invention is composed of conductive metals including at least one of a group comprising copper, yellow copper, phosphor bronze, beryllium and etc.

The electric connector according to the present invention comprises a plurality of electric connector main bodies 70, and an electric connector linking part 78 for electrically linking each electric connector main body. Each electric connector main body has an upper surface 71 of a plate shape including a wire insertion hole 72 for inserting a lead wire of an electronic component or a wire (hereinafter, referred to as the “lead wire”). The electric connector linking part 78 is integrally formed with the upper surface 71. The upper surface 71 of the electric connector and the electric connector linking part 78 are composed of conductive thin metal film of a plate shape so as to be electrically conductive to each other. If the lead wire (not shown in the drawing) is inserted into the wire insertion hole 72, the upper surface 71 of the electric connector and the electric connector linking part 78 become electrically conductive thereto as well because the inserted lead wire is compressed by an inner side of a side surface supporting part 73 which is integrated with the side surface of the upper surface 71. An electric connector fixing part 74 is formed on a lower section of the side surface supporting part for fixing the electric connector main body if inserted into the board.

The connector fixing part may comprise a mono-protrusion 75 protruded in a horizontal direction alone for tightly fixing the electric connector main body if inserted into the board. As shown in FIG. 7, a lower end protrusion 76 having protrusions at both ends is formed at lower ends of the electric connector fixing part 74. A lead wire supporting groove 77 is formed in the middle of the lower end protrusion 76 for supporting the lead wire inserted between the protrusions of the lower end protrusion 76 so as not to be slipped. As shown in FIG. 7, the electric connector linking part 78 is of a neck or a notch shape having a width narrower than the upper surface 71. This is to enable a user to easily twist or cut the electric connector linking part 78.

The electric connector according to the present invention may be fabricated with thin metal film having a thickness, for example, ranged 0.1˜1 mm by puncturing with press or in a desired shape, or by chemical etching. A final structure of the electric connector can be obtained by bending the thin metal film after shaping it as desired by undergoing the above process.

The wire insertion hole 72 is punctured by pressing the thin metal film with the press.

FIG. 8 is a front-plan view of the electric connector in FIG. 7 seen from the direction of 81. A side surface supporting part 92 is bent so as to be electrically and physically connected to the side of the upper surface 91 5 of the electric connector. A cut surface 93 is shown in the electric connector linking part. The inner surface of the side surface supporting part has an electrically conductive contact section 94, with which the lead wire will be in contact. Here, the side surface supporting parts performs a function of supporter for the electric connector main body when its lower section is inserted into the hole (not shown in the drawing) of the board.

FIG. 9 is a side view of the electric connector in FIG. 7 seen from the direction of 82.

A mono-protrusion 102 is formed on a lower section of the side surface supporting part 101 to perform a function of engagement by fixing the electric connector main body onto the board when the electric connector main body is inserted into the board. Another mono-protrusion 103 is also formed on its opposite side of the side surface supporting part in an opposite direction. The reason for using the term of “mono-protrusion” is because the protrusion orients one side only in a horizontal direction of the side surface supporting part 101.

As described above, the side surface supporting parts facing each other at both sides are formed zig-zag so as to be easily inserted and engaged into the electric connector insertion hole of the board. To be specific, the mono-protrusion has a structure of slanted protrusion. Therefore, when a side surface supporting part is inserted into the connector insertion hole of the board, the mono-protrusion is inserted while being pushed. Once completely inserted, it functions as a step or threshold of preventing easy slipping out.

A lower end protrusion 104 is formed at both lower ends of the side surface supporting part. A lead wire supporting groove 105 is formed in the middle for suspending the lead wire.

Since the electrically conductive linking part 107 is of a groove or notch shape, it can be easily bent or cut even a slight force laid thereon by a user.

The lead wire inserted into one wire insertion hole is electrically linked to other lead wires, which have been inserted into other wire insertion holes of different electric connector main body, through the electric connector linking part.

In other words, the electric current flowing through a lead wire inserted into a wire insertion hole and being in contact with side surface supporting parts of one electric connector main body streams toward other lead wires of other electronic components, which have been inserted into other electric connector main body, through the side surface supporting part and the electrically conductive linking part linked to said other electric connector main body.

Thus, the electrically conductive linking part becomes a path of flowing the electric current between different electronic components. Accordingly, a necessary circuit can be constructed by allowing the electronic components, which have been inserted into different electric connector main bodies, to be connected or disconnected electrically depending on whether the electric connector linking parts between them are linked or cut.

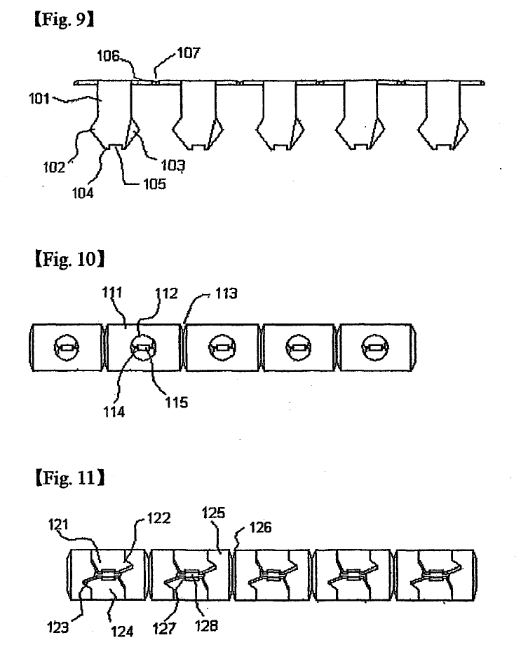

FIG. 10 is a top-plan view of the electric connector in FIG. 7 seen from the direction of 83. A wire insertion hole 112 is formed on an upper surface 111 of the electric connector main body. An electric connector linking part 113 is located between the wire insertion hole 112 and the adjacent electric connector main body in the form of a side wedge groove having a width narrower than the upper surface 111 so that the electric connector linking part can be easily cut or bent. The electric connector linking part may be formed as a wedge-shaped groove, on the upper surface or/and side surface of which a notch is formed. The metal plate such as a copper plate is flexible and easily bent. If excessively bent, the bent spot is broken and separated.

As shown in FIG. 10, a lower end protrusion 114 and a lead wire supporting groove 115 are formed at lower ends of the side surface supporting part of the electric connector. The lead wire supporting groove may be located either at both sides to face each other or at one side only of the side surface supporting part.

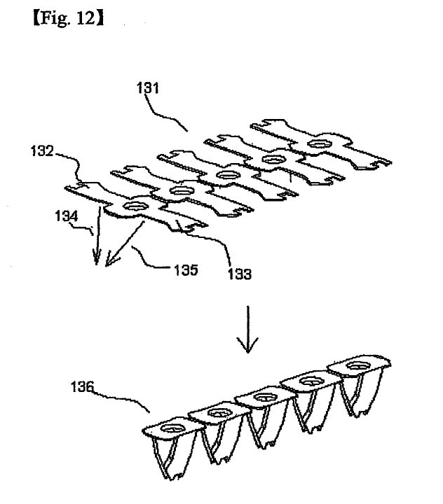

FIG. 11 is a bottom-plan view of the electric connector in FIG. 7.

A mono-protrusion 122 protruded at one side only is formed in one side surface supporting part 121 so as to function as an engaging means. Another mono-protrusion 123 protruded at the other side is formed to face the mono-protrusion 122. An electric connector linking part 126 is also formed to have a side wedge groove. A lower end protrusion 127 is formed at lower ends of the side surface supporting part of the electric connector, and a lead wire supporting groove 128 is subsequently formed.

FIG. 12 illustrates a process of fabricating the electric connector. A plate 131 is fabricated as drawn by pressing or etching thin metal film having a thickness, for example, ranged 0.1 mm˜1 mm. The thin metal film may be composed of copper, copper alloy or other metal. As shown in this process, the electric connector linking part, the upper surface, the side surface supporting part, the protrusion and the lead wire supporting groove are integrated into one body so as to simplify the fabricating process and naturally form an electrically conductive state. The electric connector 136 is completed by pressing the portion 132, 133 of the side surface supporting part with a press to be bent toward the directions of 134, 135.

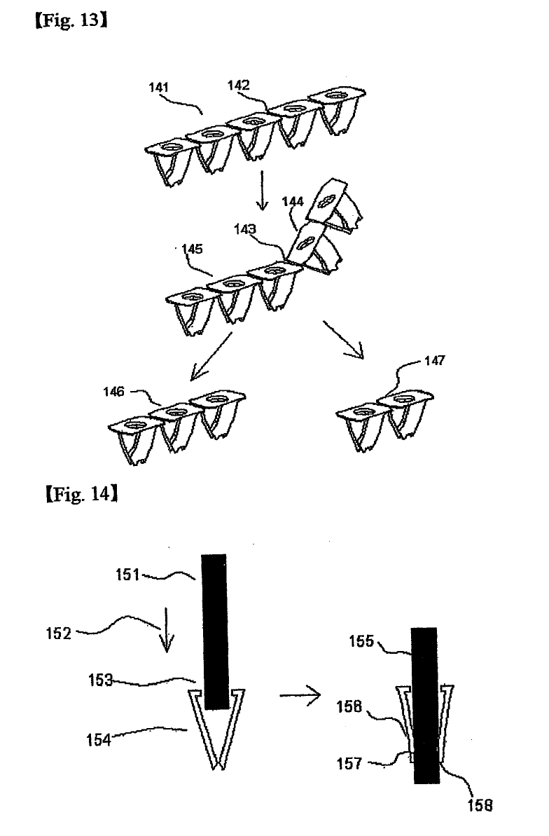

FIG. 13 shows a process of separating the electric connector into each electric connector main body by means of the electric connector linking part, which is of an upper surface wedge or a side surface wedge groove shape.

Metals have a bending characteristic due to its flexibility. Therefore, metals are bent when a shear stress exceeds a certain value. If the electric connector linking part 142 of the electric connector 141 is pressed from both sides, both tips are bent toward the directions of 144, 145. If the bending stress or angle exceeds the range of its flexibility or bending is repeated a number of times, the electric connector can be separated into two pieces 146, 147. Although FIG. 13 exemplified an electric connector having five electric connector main bodies only, it is possible to bend or separate an electric connector having tens or hundreds of electric connector main bodies into a desired length.

FIG. 14 exemplifies a case that a lead wire is electrically linked to the electric connector when the lead wire is inserted into a wire insertion hole of the electric connector. FIG. 14 shows a case of inserting the lead wire into a structure identified by a cross-section of the electric connector.

Copper wire is generally used for the lead wire 151, which is identified in black color. Until immediately prior to inserting the lead wire 151 into the wire insertion hole 153 of the electric connector toward the direction of 152 in the left part of FIG. 14, the lead wire is not yet in contact with the inner surfaces of side surface supporting parts of the electric connector. Accordingly, the side surface supporting part 154 maintains its original shape.

If the lead wire 155 is further inserted in the right part of FIG. 14, the lead wire pushes the elastic side surface supporting part 156. The side surface supporting part is subsequently bent outward due to the volume of the lead wire inserted while contacting an inner surface 157 thereof. Then, the inner surface 157 of the side surface supporting part becomes physically and electrically in contact with the lead wire. The electric connector main body is electrically linked to the inserted lead wire in this manner according to the present invention. At this stage, the lower tip of the inserted lead wire is supported by the lead wire supporting groove so as not to be biased (as identified by 158) at the lower of the side surface supporting part.

The following is a description of the structure of an electric circuit board according to the present invention.

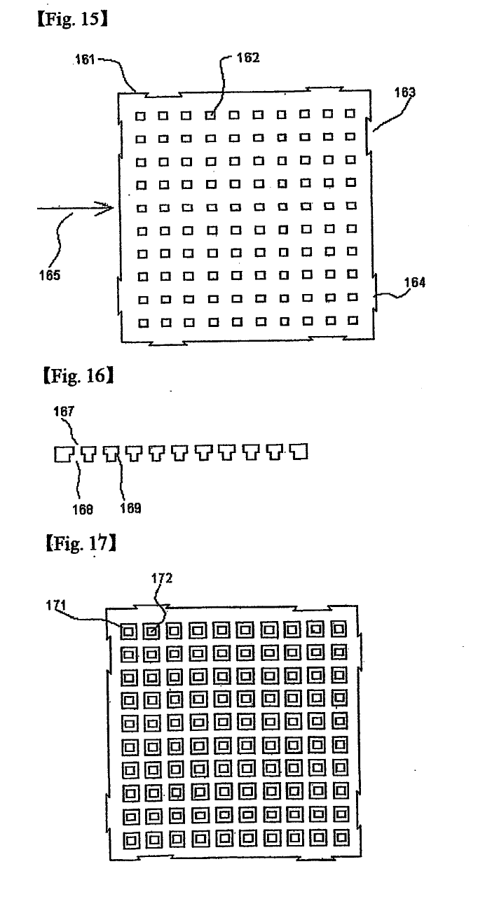

FIG. 15 is a top-plan view of the board, which is capable of receiving the electric connector 161, according to embodiments for carrying out the present invention. A plurality of connector insertion holes are punctured for insertion of the electric connectors in the board 161. Assembly prominence and depression sections 163, 164 are also formed in the board 161 for assembling of the boards. The electric connector insertion hole of the board has a penetrating structure in vertical direction so as to receive the electric connector fixing part and the lead wire. A part of the electric connector insertion hole has a width narrower than the fixing part of the electric connector so as to fix the electric connector.

Plastics, Styrofoam or rubber may be used as a material of the board.

The electric connector insertion holes are aligned densely and at regular intervals so that the electric connectors can be freely positioned. Although FIG. 15 exemplifies holes of a rectangular shape, holes of a circular shape or of other symmetrical shapes can also be employed.

FIG. 16 is a cross-sectional view of the board 161. The upper section 167 of the electric connector insertion hole is smaller than that lower section 168 in width or diameter. Therefore, the electric connector threshold or step((hereinafter, referred to as the “step”) 169 is naturally formed in the middle of the electric connector insertion hole.

FIG. 17 is a bottom-plan view of the board seen from below. The section 171 of the hole is larger than the section 172 of the upper side.

FIG. 18 is a perspective view of the board. A step is formed in the middle so as to differentiate the size of the holes between the upper section and the lower section of the electric connector insertion hole 173 penetrated in vertical direction. Assembly prominence and depression parts 174, 175 are also formed for assembling the boards.

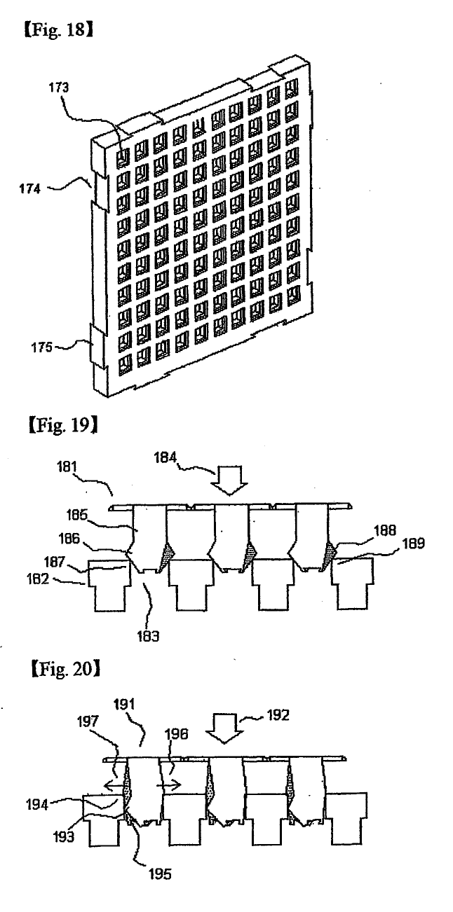

FIG. 19 illustrates a process of inserting the electric connectors into the board. The entire width of the electric connector fixing part including the mono-protrusion 186 of the side surface supporting part is larger than that of the upper section of the electric connector insertion hole of the board. Therefore, when the side surface supporting part 185 of the electric connector 181 is inserted into the electric connector insertion hole 183 in the direction of 184, the electric connector is suspended on the electric connector insertion hole. Each of the side surface supporting parts, which are facing each other, has oppositely protruded mono-protrusions. Thus, the side surface supporting parts are suspended in the opposite direction. As shown in FIG. 19, the mono-protrusion 186 is suspended on one side 187 of the electric connector insertion hole of the board, while the other mono-protrusion 188 of the opposite fixing section is suspended on the opposite side 189 of the upper end of the electric connector insertion hole. The other mono-protrusion 188 of the opposite fixing section was drawn in shade for easy distinction.

FIG. 20 illustrates a process of inserting the electric connector into the electric connector insertion hole.

If the electric connector 191 is further inserted, the slanted part of the mono-protrusion 193 is twisted and pushed into the side 194 of the hole of the upper surface of the board toward the direction of 196. The other mono-protrusion of the opposite fixing section is also slipped and inserted toward the opposite direction of 197.

Because the thin metal film of the electric connector is elastically deformed due to elasticity, the mechanism enabling the fixing section of the lower part of the electric connector, which has a larger width, to be inserted into the electric connection insertion hole which has a smaller width.

FIG. 21 illustrates a complete insertion of the electric connector into the electric connector insertion hole of the board. If the electric connector 201 is completely inserted, the mono-protrusion 205, 206, which have a width larger than that of the hole 204 of the lower part of the board, return to their original size. Also, the retrieved size is greater than the width of the upper section of the hole so as to suspend the electric connector on the step 207 of the board like a hook and to prevent slipping.

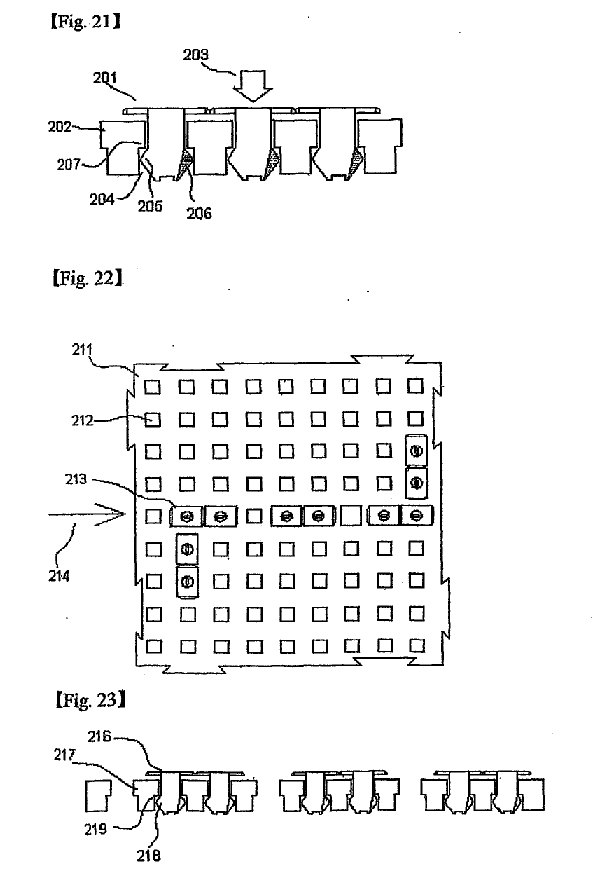

FIG. 22 is a top-plan view of the electric connector inserted into the board.

The electric connector 213 according to the present invention can be freely inserted into an arbitrary position of the electric connector insertion hole 212. If the electric connector is inserted into the board, the electric connector fixing part is suspended and fixed on the step of the lower section thereof.

FIG. 23 is a cross-sectional view of the board 211 in FIG. 22. The mono-protrusion 218 of the lower section of the electric connector 216 inserted into the board 217 is suspended and fixed onto the step 219 of the board.

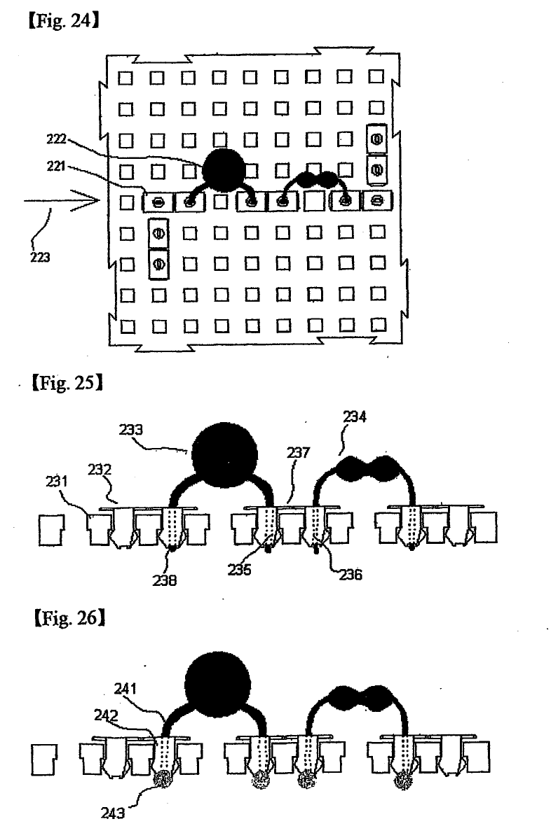

FIG. 24 exemplifies a case of inserting electric connectors into the board as in FIG. 22, and assembling electronic components onto the inserted electric connectors. This is one of the most outstanding characteristics of the present invention. An electric connector 221 is inserted into any desired position, and a lead wire of the electronic component 222 or other wire may be inserted and fixed onto the electric connector main body. Each electric connector main body with inserted lead wire becomes electrically conductive or non-conductive depending on connection or disconnection of the electric connector linking part. Therefore, large and small size electronic circuits are fabricated with such elements. FIG. 24 helps an easy understanding of the advantage of the present invention that is capable of free construction of an electronic circuit with a simple process of cutting and insertion without soldering.

FIG. 25 is an elongated sectional view of the embodiment in FIG. 24. Lead wires of electronic components 233, 234 are inserted into the electric connector 232, which has been inserted into the electric connector insertion hole of the board 231. If the lead wire has a long length, extra length of the lead wire may be left out of the lower part of the electric connector as identified by the reference numeral 238.

If the lead wires of the electronic components 233 and 234 have been inserted into different electric connector bodies, respectively, the lead wire of the electronic component 233 is electrically in contact with the inner surface of the electric connector main body 235, while the lead wire of the electronic component 234 is also electrically in contact with the inner surface of the other electric connector main body 236. Since the two electric connector main bodies are electrically linked by the electric connector linking part 237, the two electronic parts 233, 234 are electrically linked to each other as a consequence. Thus, electronic components are interlinked to each other by simply being inserted into the electric connectors according to the present invention. Another advantage of the present invention is a free alignment of the electric connectors on the board that determines electrical positions of the electronic components.

FIG. 26 illustrates fixing of the lead wire 238, which has been left out of the lower part of the electric connector in FIG. 25, onto the electric connector. The lead wire may be fixed as identified by the reference numeral 243 by melting adhesive, electrically conductive paste or lead so as to enhancing contact between the lead wire 241 and the electric connector 242 of the electronic components that have already been electrically and physically linked to each other. However, such fixing process is not critical to achieving an object of the present invention but is mere one of the embodiment for carrying out the present invention when a tighter fixation is required.

FIG. 27 illustrates a structure of the electric connector according to another embodiment for carrying out the present invention. This mode is characterized by an outwardly verged lower part of the side surface supporting part of the electric connector. Hereinafter, the outwardly verged lower part will be referred to as the “lower open part 251.”

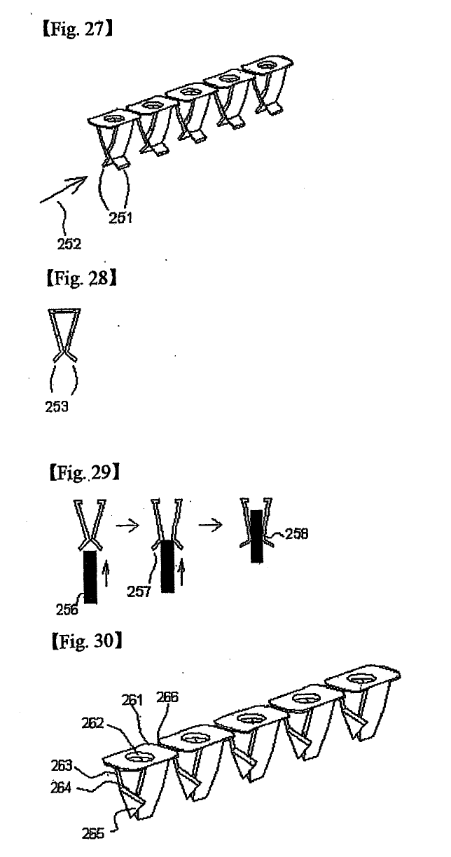

FIG. 28 is a view of the electric connector in FIG. 27 as seen from the direction of 252.

FIG. 29 illustrates a process of inserting the lead wire into the electric connector in FIG. 27.

If the lead wire 256 is inserted from the lower part of the electric connector, the lower open part 251 is opened toward the direction of 257 so that the lead wire can be inserted. While being inserted, the lead wire is electrically in contact with the inner surface of the electric connector as identified by the reference numeral 258. This mode has an advantage that the lead wire may be inserted from any side of the wire insertion hole; either from its upper section or from the lower section of its lower part.

FIG. 30 shows the electric connector according to another embodiment for carrying out the present invention. This mode has almost the same structure as the electric connector in FIG. 7 except that the side surface supporting part is horizontally bent to form a horizontally bent portion 256.

The horizontally bent portion 256 of the side surface supporting part is horizontally folded on the opposite side surface supporting part. This structure serves to support the lead wire by preventing the lead wire from being slipped out of the side surface supporting part while fixing the electric connector main body onto the board.

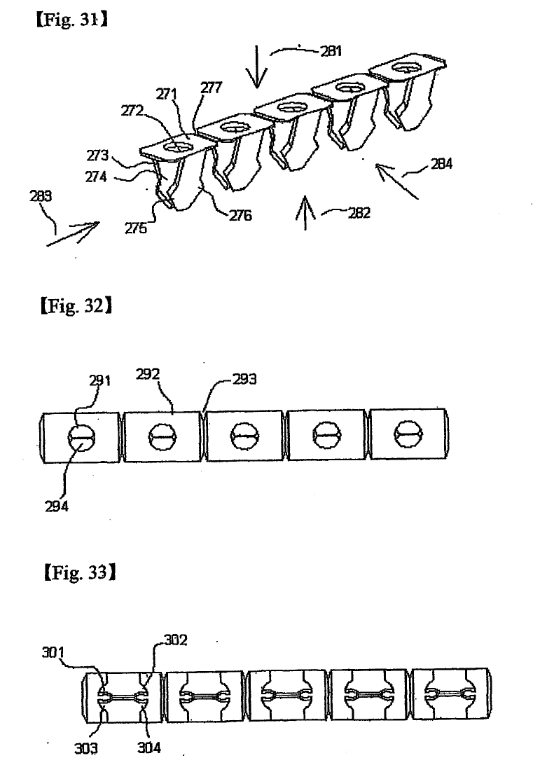

FIG. 31 shows the electric connector according to another embodiment for carrying out the present invention. This mode is characterized by dual protrusion parts, which are bent inward to form protrusions 275, 276 at both ends on the side surface supporting part.

As shown in FIG. 31, an upper surface 271 and wire insertion hole 272 composed of conductive thin metal film are formed on the upper section of the electric connector. The mode in FIG. 31 reflects the same construction as that in FIG. 7 in that is includes the side surface supporting part 273 and the electric connector separating part 277.

The dual protrusion parts 275, 276 are of a curved shape and bent toward the middle of the electric connector. Therefore, when the dual protrusion sections 275, 276 are inserted into the electric connector insertion hole by applying pressure, their shapes are deformed and further bent. Once completely inserted, they return to their original shape and suspended on the step of the hole of the board.

FIG. 32 is a top-plan view of the electric connector in FIG. 31.

FIG. 33 is a bottom-plan view of the electric connector in FIG. 31 illustrating the structure thereof. Dual protrusion parts 310, 302 are formed in one side surface supporting part, and dual protrusion parts 303, 304 are formed in the opposite side surface supporting part as well. The dual protrusion parts are curved and bent toward the middle of the electric connector. This embodiment is to facilitate easy inward bending of the dual protrusion parts when inserted into the board in the curved shape. The same effect can be obtained even if the dual protrusion parts are bent toward the middle of the electric connector in a lineal shape rather than in a curved shape.

FIG. 34 is a front-plan view of the electric connector in FIG. 31 seen from the direction of 283. FIG. 34 shows a side supporting section 307 bent down straight from an upper surface 306 of the electric connector. The inner surface 309 is a portion, with which an inserted lead wire of the electronic component is to be in contact.

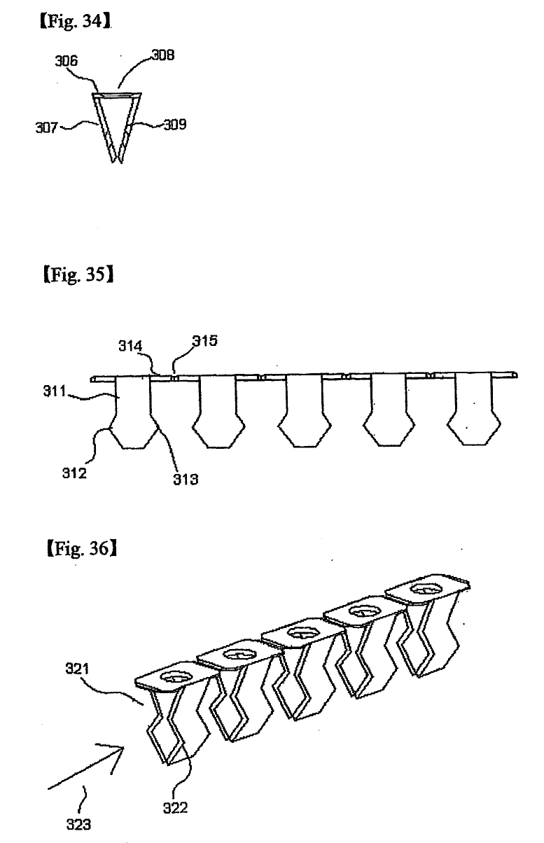

FIG. 35 is a side view of the electric connector in FIG. 31 seen from the direction of 284. FIG. 35 shows dual protrusion 312, 313 having protrusions at both lower ends of the electric connector.

FIG. 36 illustrates the electric connector according to another embodiment for carrying out the present invention. This mode reflects another type of electric connector fixing part formed at lower ends of the bent section on the side surface. As shown in FIG. 36, the side surface supporting part 321 includes a dually bent fixing part 322 protruded by dual folding.

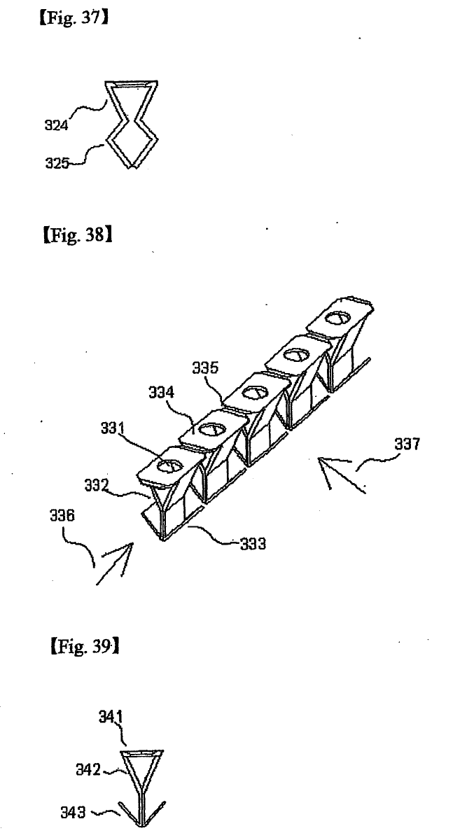

FIG. 37 is a front-plan view of the electric connector in FIG. 36 seen from the direction of 323. The dually bent fixing part 325, which has been dually bent from the lower ends of the side surface supporting part 324, is suspended on the step of the board when inserted into the board.

The dually bent fixing part primarily functioning to fix the electric connector also functions to contact the lead wire by touching its tip with the side of the board and laying a more powerful pressure on the lead wire when the lead wire is inserted.

FIG. 38 illustrates the electric connectors according to another embodiment for carrying out the present invention. This mode is characterized by an outwardly bent part 333 located at lower ends of the side surface supporting part.

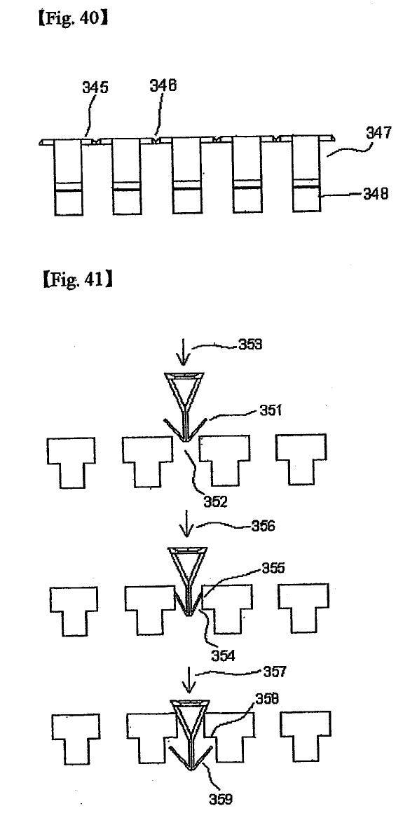

FIG. 39 is a top-plan view of the electric connectors in FIG. 37 seen from the direction of 336. FIG. 39 shows an outwardly bent part 343, which is outwardly bent from the side surface supporting part 342 so as to function as an electric connector fixing means. As shown in FIG. 39, this outwardly bent part has an angle opened greater than 180°. By contrast, the lower open section in FIG. 27 has an angle opened less than 180°. Thus, these two modes have structural differences.

FIG. 40 is a side view of the electric connectors in FIG. 37 seen from the direction of 337.

FIG. 41 illustrates a process of inserting an electric connector, which comprises the outwardly bent part, into the board.

When inserted in the direction of 353, the electric connector is suspended on the side of the upper hole because the entire width of the outwardly bent part 351 is wider than that of the entrance of the hole on upper surface of the electric connector insertion hole of the board. If further inserted in the direction of 356, the outwardly bent part 354 is suspended on the side 355 of the hole on the upper surface of the electric connector insertion hole, and bent to be fully inserted. Once completely inserted in the direction of 357, the outwardly bent part 359 returns to its original shape so as to fix the electric connector by being suspended on the step 358 of the board.

As in case of the dual bent part, the outwardly bent part also presses and contacts the side surface of the lead wire with more powerful elastic pressure by touching the side of the electric connector insertion hole of the board when the lead wire is inserted.

FIG. 42 illustrates electric connectors according to another embodiment for carrying out the present invention. This mode has a structure of a cylindrical and gourd shape. The wire insertion hole is penetrated down straight. A convex cylindrical protrusion 363 is formed at a lower end of the main body of a cylindrical shape so as to fix the electric connector. The wire insertion holes are electrically linked by the electric connector linking part 365. The electric connector of a cylindrical shape can be fabricated mainly by molding, etc.

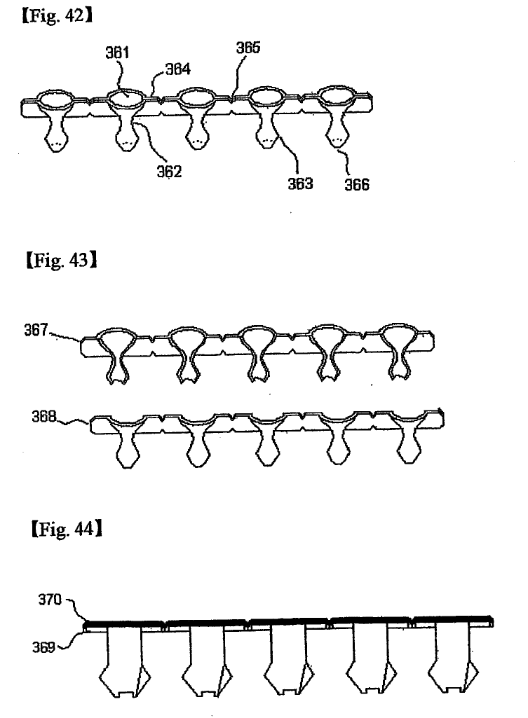

FIG. 43 illustrates a process of fabricating the structure of a cylindrical shape according to another embodiment for carrying out the present invention. Divided parts 367, 268 of the electric connectors of a cylindrical shape are formed to face each other by pressing, and attached to each other by means of conductive adhesive or plasma fusion, etc.

The function as the electric connectors can be enhanced by attaching plastics on the structures according to the above embodiment for carrying out the present invention. For instance, the electric connector in FIG. 7 can be more easily separated by enhancing the bending and broken characteristics through attaching plastics on the electric connector linking part. Furthermore, such attachment of plastics also serves to avoid damages possibly resultant from external impact.

FIG. 44 is a side view of the electric connectors in FIG. 7 showing a structure including plastic plates on the upper surface thereof. The plastic plate 370 may be fixed on the upper surface by means of adhesive, etc. A wire insertion hole for inserting the lead wire as well as a neck or a notch for separation of the electric connectors may be formed on each corresponding position of the plastic plate.

It is also possible to coat the electric connector with plastics in addition to the method of attaching plastics to the upper surface of the electric connector.

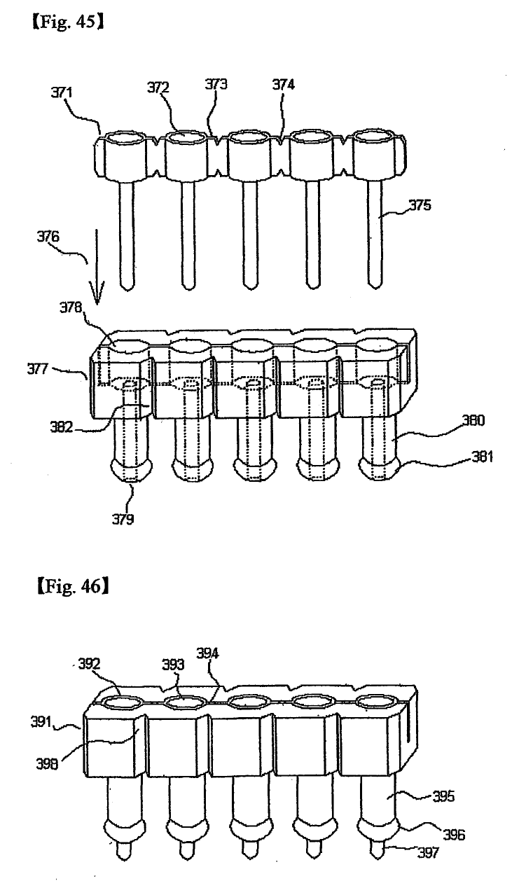

FIG. 45 illustrates an electric connector main body 371 composed of a conductive metal and a plastic coating 377 surrounding the same according to another embodiment for carrying out the present invention.

The metallic electric connector main body 371 comprises an upper part 373 including a wire insertion hole 372, and an electric connector linking part 374 formed with wedge grooves. A metallic supporting rod 375 for supporting the electric connector main body constitutes the lower part of the electric connector. The metallic supporting rod includes a wire insertion hole therein for passing a lead wire. The structure is completed by inserting the metallic electric connector main body into the plastic coating 377 in the direction of 376.

The plastic coating comprises a metallic electric connector insertion hole 378, which is penetrated to its lower end 379 for inserting the metallic electric connector. The plastic coating further comprises a lower insertion section 380 for surrounding the metallic supporting rod, an electric connector fixing part 381 of a ring shape protruded at lower end of the lower insertion section 380, and an electric connector linking part 382 including wedge grooves.

FIG. 46 illustrates an assembly of the structures in FIG. 45. Assembly is completed by inserting the metallic electric connector main body 392 into the plastic coating 391.

FIG. 47 illustrates a board comprising an electric connector insertion hole of a circular shape according to another embodiment for carrying out the present invention unlike the electric connector insertion hold of a rectangular shape in FIG. 15.

The board 401 comprises an electric connector insertion hole 402, and an assembly prominence and depression section 403 for assembling the boards.

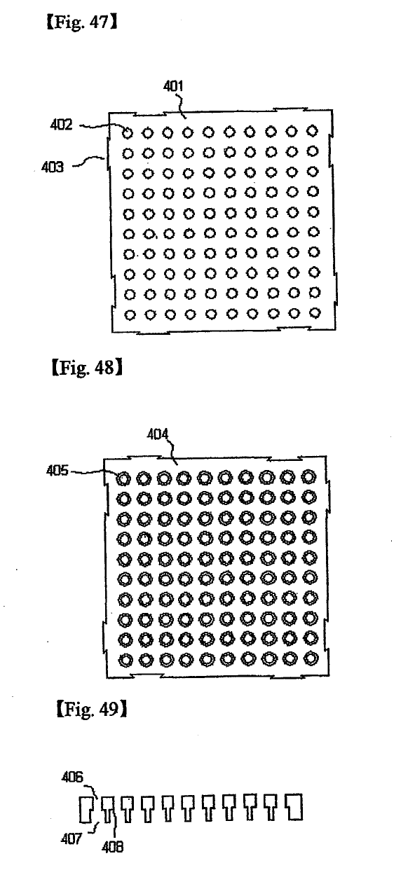

FIGS. 48 and 49 are a bottom-plan view and a cross-sectional view of the board in FIG. 47 seen from below. The lower hole 407 was designed to be larger than the upper hole 406 in the board 404 so as to form a step 408 for fixing the electric connector fixing part in the middle.

A board with a variety of electric connector insertion holes may be fabricated in the above manners. The electric connector insertion holes may take other symmetrical shapes than the rectangular or circular shape, including a hexagonal or octagonal shape.

In case of the electric connector insertion hole of an octagonal shape, its symmetrical nature realized not only in vertical and horizontal directions but also in diagonal direction is advantageous for inserting the electric connector from various directions.

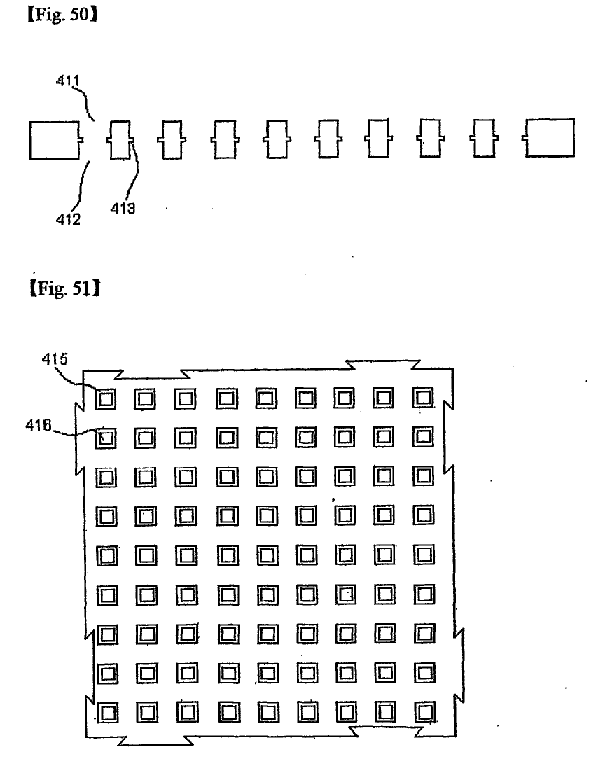

FIG. 50 is a cross-sectional view of the board according to another embodiment for carrying out the present invention.

The board in FIG. 50 has the same or similar width in the upper part and the lower part of the electric connector insertion hole. The protrusion 413 in the middle of the hole functions as a step for engagement with the electric connector. To be specific, the upper section 411 and the lower section 412 of the electric connector insertion hole have a symmetrical shape, and an intermediary protrusion step 413 is formed in the middle.

FIG. 51 is a top-plan view of the structure in FIG. 50. Here, the top-plan view is the same as the bottom-plan view because the upper section and the lower section have a symmetrical shape.

FIG. 52 exemplifies a case of assembling the electric connectors with the board in FIG. 50.

As shown in FIG. 52, the electric connectors in FIG. 7 may be inserted into the board from the upper section 421 of the electric connector insertion hole. However, the electric connectors may also be inserted from the lower section 423 of the electric connector insertion hole. Regardless of the inserting directions, the electric connectors are always fixed onto the step 425, which is an intermediary protrusion of the electric connector insertion hole of the board.

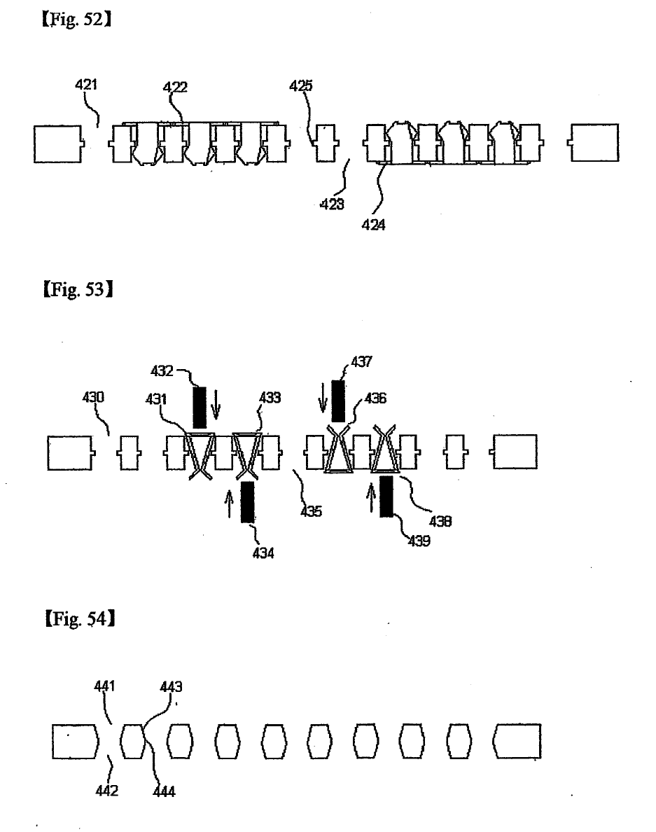

FIG. 53 exemplifies a case of assembling the electric connectors having a lower open section in FIG. 27 with the board in FIG. 52. A lead wire 432 has been inserted into one electric connector main body 431 from an upper hole 430 of the board through the wire insertion hole, while another lead wire 434 has been inserted into another electric connector main body 433 from the lower open section. In case of an electric connector main body 436 inserted from a lower hole 435 of the board, a lead wire 437 may be inserted from above through the lower open section. In case of another electric connector main body 438, a lead wire 439 may be inserted from below through the wire insertion hole.

The board of a symmetrical shape between its upper section and its lower section and with a step including an intermediary protrusion has an advantage that the electric connectors and lead wires may be inserted and fixed from any directions. Using such advantage can serve to notably improve the assembling density of an electronic circuit by utilizing both surfaces of the board.

FIG. 54 illustrates the board according to another embodiment for carrying out the present invention. The board has an electric connector insertion hole of a symmetrical shape between its upper section and its lower section. The electric connector insertion hole becomes narrower toward its mid-portion so as to fix the electric connectors. Hereinafter, this mid-portion where the electric connector is fixed will be referred to as the “slanted protrusion.”

The surface 443 of the electric connector insertion hole is slanted until it reaches the protrusion. Its narrowest mid-portion is a slanted protrusion 444.

FIG. 55 is a top-plan view of the structure in FIG. 54. FIG. 55 shows a slanted protrusion 446 and an electric connector insertion hole 447.

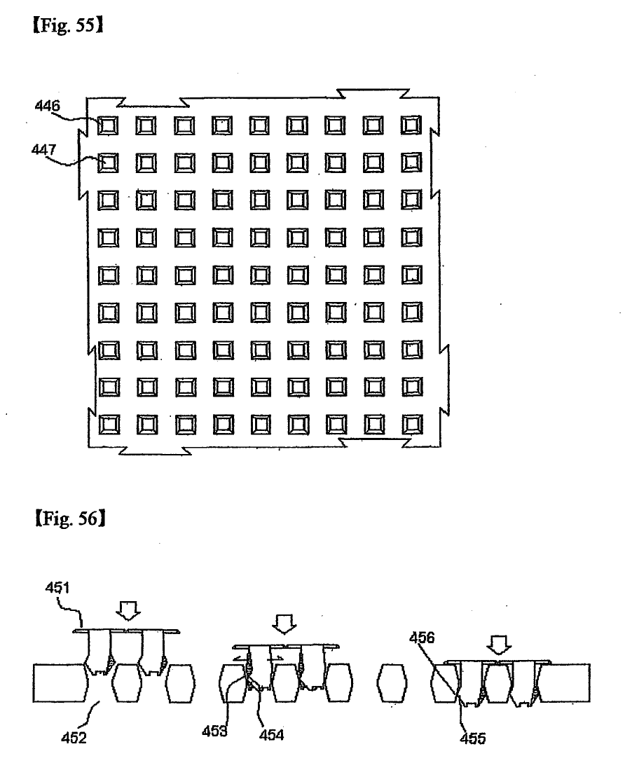

FIG. 56 illustrates a process of inserting the electric connectors according to the present invention into the board having the slanted protrusion.

If the electric connector main body 451 having a mono-protrusion 454 is inserted into the electric connector insertion hole 452 of the board, the mono-protrusion 454 of the electric connector is inserted while its shape is deformed along the slanted surface 453 of the slanted protrusion. If completely inserted, the mono-protrusion 455 is suspended and fixed onto the slanted protrusion 456.

The electric connector insertion hole according to the above embodiment for carrying out the present invention may have a symmetrical structure in its upper and lower holes. Otherwise, it may take a rectangular, a circular, or their combined shape depending on the layout of the electric connector.

Also, the slanted protrusion may be formed on one side only of the electric connector insertion hole. In other words, the slanted protrusion is formed along a partial peripheral only rather than all around the peripheral of the circle. In that case, the electric connector can be assembled so that the electric connector main body can be smoothly inserted with reduced resistance.

FIG. 57 is a perspective view of the board, which is equivalent to the electric connector, according to another embodiment for carrying out the present invention. The board 461 may be composed of elastic polymer such as rubber. Here, the elastic polymer refers to a material having elasticity among the polymer materials such as plastics. The advantage of the board 461 composed of such material is that the electric connector may be inserted and fixed without any electric connector insertion hole like the board according to the aforementioned embodiment. In other words, plastics have a weaker solidity than metal, and in particular, polymer materials easily subside if pushed by metal.

Therefore, if the electric connector is pushed against the surface of the board of an elastic polymer material, which has no electric connector insertion hole or a step, the electric connector fixing part can be fixed due to elasticity of the elastic polymer. Such board 461 of a polymer material can be used for assembling an electronic circuit without a electric connector insertion hole, and has an advantage of realizing an alignment of the electric connectors on arbitrary positions.

Outstanding materials used for an elastic polymer board are elastic rubber and foaming polymer materials. In particular, elasticity or extension of synthetic rubber of the rubber materials can be controlled chemically. The foaming polymer materials refer to Styrofoam or foaming silicon rubber materials that are manufactured by arbitrarily generating foams in polymer materials.

FIG. 58 illustrates a process of inserting the electric connector in FIG. 31, which has a dual protrusion as a fixing means, into the elastic polymer board. The electric connector in FIG. 58 is a front-plan view of the structure in FIG. 31 seen from the direction of 283.

As shown in FIG. 58 (a), pressure is laid on the electric connector 466 so as to be inserted into the elastic polymer board 465 in the direction of 468. Here, the electric connector, which is composed of a metal material, has a greater strength and sharper tip than the elastic polymer board. Therefore, the electric connector is inserted in the direction of 467 while pushing the surrounding elastic polymer.

If the electric connector is completely inserted, the upper surface of the electric connector is in contact with the upper surface of the board. By laying more pressure onto the electric connector 471 in the direction of 469 as shown in FIG. 58 (b), the electric connector 471 is completely inserted into the elastic polymer board 470.

The electric connectors can be electrically linked by inserting a lead wire into the electric connectors that have been inserted and fixed onto the elastic polymer board.

As shown in FIG. 58 (c), the lead wire 474 inserted into the wire insertion hole of the electric connector 473, which has been inserted into the board 472, is electrically in contact with the inner surface of the side surface supporting part 475 as identified by the reference numeral 476. Here, the elastic polymer material surrounding the side surface supporting part 475 is pushed due to the volume of the lead wire. The side surface of the inserted lead wire is subsequently more pressed onto the side surface supporting part due to the repulsive power.

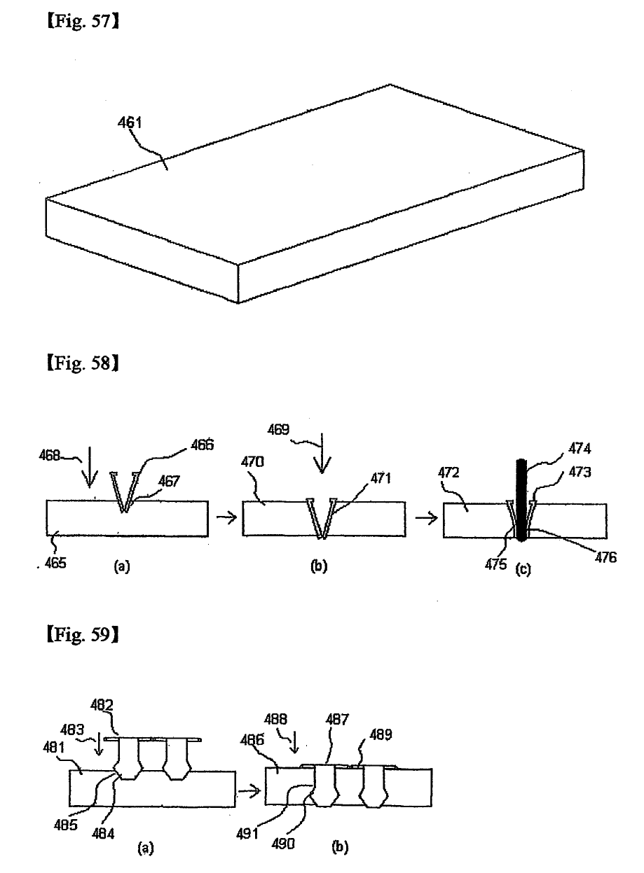

FIG. 59 is a side view of the electric connector in FIG. 31 having a dual protrusion. FIG. 59 illustrates a process of inserting the electric connector into the elastic polymer board in the direction of 284 by simply exemplifying two electric connector main bodies only.

As shown in FIG. 59 (a), if the electric connector 482 is inserted into the elastic polymer board 481 in the direction of 483, slanted lower surface of the dual protrusion , which is the fixing means at the lower end of the side surface supporting part, pushes the surrounding elastic polymer material 485.

FIG. 59 (b) illustrates the case when the electric connector has been completely inserted into the board. The dual protrusion 490 of the side surface supporting part, which is the electric connector fixing part, pushes the surrounding elastic polymer material. Thereafter, the pushed part is elastically retrieved, and fixes the dual protrusion of the electric connector by surrounding it.

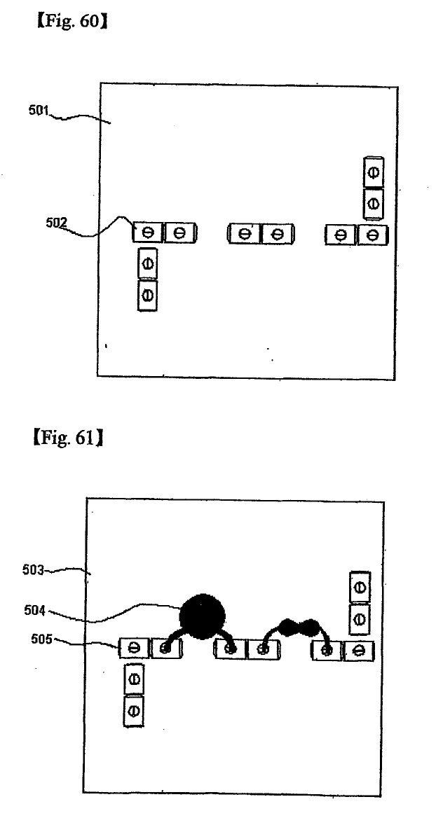

FIG. 60 is a top-plan view of the electric connector as assembled with the elastic polymer board. The electric connector 502 is inserted and fixed onto a desired position off the elastic polymer board 501.

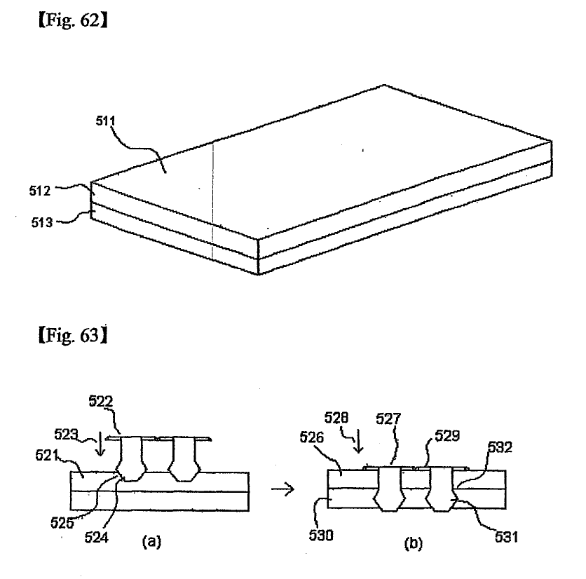

FIG. 61 exemplifies an assembly of the electric connector, which has been inserted and fixed onto the elastic polymer board, with an electronic component.

An electronic circuit can be completely fabricated by inserting the electric connector 505, which has been inserted into the desired position of the elastic polymer board 503, into the electronic part 504.

In general, the elastic polymer material is easily bent, and tends to be deformed when the size of the board becomes larger. To solve this problem, the board was designed in a dual-layered structure, in which a rigid plate composed of a rigid material receivable of the electric connector but not easily bent, is attached to the lower part of the elastic polymer board by means of adhesive, etc.

FIG. 62 is a perspective view of the board of a dual-layered structure according to the present invention.

The upper surface 511 of an elastic polymer board 512, which is of a dual-layered structure for inserting the electric connector, is composed of an elastic polymer material, while the lower layer 513 is composed of a rigid material for maintaining the board shape and receiving the electric connector without being bent.

Examples of the rigid material of the rigid plate constituting the lower layer of the board of a dual-layered structure are Styrofoam or thick paper, which is receivable of the electric connector and maintaining rigidity. Styrofoam is a kind of foaming material that can maintain its shape while receiving an electric connector inserted therein.

FIG. 63 is a side view of the electric connector illustrating a process of inserting the electric connector, which has the dual protrusion as an electric connector fixing part in FIG. 31, into the board of a dual-layered structure in the direction of 284. For convenient illustration, the electric connectors were exemplified as having two wire insertion holes.

As shown in FIG. 63 (a), if the electric connector 522 is inserted into the upper surface of the elastic polymer board 521 of a dual-layered structure in the direction of 523, the lower slanted surface 524 of the dual protrusion, which is a fixing part or means at lower end of the side surface supporting part, is inserted into the board while pushing the surrounding elastic polymer material as identified by the reference numeral 525.

FIG. 63 (b) illustrates a case when the electric connector has been completely inserted into the board. If the upper surface 529 of the electric connector 527 is completely inserted into the upper surface of the elastic polymer board 526 in the direction of 528, the electric connector fixing part is inserted into the lower part 530 of the elastic polymer board 526 of a dual-layered structure.

The elastic polymer board of a dual-layered structure according to the present invention realizes an insertion of the electric connector into the board without forming electric connector insertion holes on the board. The elastic polymer board of a dual-layered structure according to the present invention also has an advantage of avoiding deformation of the board, thereby serving to laying out an electronic circuit of a large size.

Another advantage of the elastic polymer board of a dual-layered structure according to the present invention is that it an electric connector can be inserted into any positions thereof. Therefore, once an electronic circuit layout is directly printed on an upper surface of the board, the electronic circuit may be fabricated while visually watching the printed layout. It is also possible to fabricate the electric circuit by inserting electronic components onto a circuit drawing on a paper sticker, which has been attached to an upper surface of the board.

### Industrial Applicability

As described above, the connector and board for fabricating an electric circuit according to the present invention has the following advantageous effects. An electric circuit can be simply fabricated in an assembled manner without undergoing a complicated and risky process such as soldering. Omitting a soldering process enables an easy dissemble of the components and recycling of the used materials. Separation of the electric connectors in the necessary parts only serves to effectively utilize the space on the board.

While the invention has been shown and described with reference to certain preferred embodiments thereof, it will be understood by those skilled in the art that various changes in form and details may be made therein without departing from the spirit and scope of the invention as defined by the appended claims.

1. (amended) An electric connector for fabricating an electronic circuit, comprising:
a plurality of electric connector main bodies; and
an electric connector linking part positioned between said electric connector main bodies for electrically connecting said electric connector main bodies, wherein
each electric connector main body include;
a wire insertion hole for inserting a lead wire of an electronic component,
a plate-shaped upper surface integrating said wire insertion hole,
side surface supporting parts integrally linked to the sides of said upper surface and elongated downward and compressing said lead wire from sides when said lead wire is inserted into the wire insertion hole so as to connect said lead wire electrically to the electric connector linking part; and,
an electric connector fixing part formed on a lower section of said side surface supporting part for supporting the electric connector main body if inserted into a board, and,
said electric connector linking part is electrically conductive to said side surface supporting parts and takes the form of a notch having a width narrower than that of said upper surface so as to be easily bent or cut, and
lead wires of the electronic components inserted into different wire insertion holes of different electric connector main bodies are electrically disconnected or connected with one another depending on the condition that the electric connector linking parts between said electric connector main bodies are cut or linked, so as that the electronic components inserted into the board can form an electronic circuit without soldering.

2. (cancelled)

3. (amended) The electric connector of claim 1, further comprising wire supporting grooves formed by protruding both ends of said side surface supporting parts for aligning tips of said wire.

4. (amended) The electric connector of claim 1, wherein the side surface supporting parts comprise a pair facing each other, and the electric connector fixing parts comprise a pair of lower open tips outwardly opened at an angle less than 180°.

5. (cancelled)

6. (cancelled)

7. (amended) The electric connector of claim 1, wherein the side surface supporting parts comprise a pair facing each other, and the electric connector fixing parts include a pair of mono-protrusions facing each other and protruded in opposite directions.

8. (amended) The electric connector of claim 1, wherein the side surface supporting parts comprise a pair facing each other, and the electric connector fixing parts include a pair of mono-protrusions horizontally bent in opposite directions.

9. (amended) The electric connector of claim 1, wherein the side surface supporting parts comprise a pair facing each other, and the electric connector fixing parts include a pair of dual protrusions protruded at both ends thereof.

10. (amended) The electric connector of claim 9, wherein said pair of dual protrusions are bent toward the middle of said electric connector main body.

11. (amended) The electric connector of claim 1, wherein the side surface supporting parts comprise a pair facing each other, and the electric connector fixing parts are dually bent to form a protrusion.

12. (amended) The electric connector of claim 1, wherein the side surface supporting parts comprise a pair facing each other, and the electric connector fixing parts include a pair of outwardly bent tips opened at an angle greater than 180°.

13. (cancelled)

14. (amended) The electric connector of claim 1, wherein the electric connector linking part include at least one of a group comprising an upper surface groove formed on an upper surface and a side surface groove of wedge-shaped formed on a side surface thereof.

15. (amended) The electric connector of claim 1, further comprising a plastic layer on said upper surface of the electric connector main body.

16. (amended) The electric connector of claim 1, wherein the electric connector main body is formed in a cylindrical shape, and the wire insertion hole penetrates the electric connector main body from the upper surface to the bottom thereof.

17. (amended) The electric connector of claim 16, wherein the electric connector main body formed in a gourd shape.

18. (amended) An electric connector assembled body inserted into a board for fabricating an electronic circuit, comprising metal electric connector and outer plastic structure; wherein
said metal electric connector comprises;
a plurality of metal electric connector main bodies of a cylindrical shape, each electric connector main body include a wire insertion hole for receiving a wire of a electronic component and a metal supporting part integrally linked to the wire insertion hole and vertically elongated for supporting; and
a metal electric connector linking part for electrically connecting adjacent electric connector main body, and
said outer plastic structure comprises;
a lower plastic insertion part having a hole in the middle thereof to be linked to the wire insertion hole of the metal electric connector;
an electric connector fixing part formed at lower end of the lower plastic insertion part, having a hole in the middle thereof; and
a plastic electric connector separation part formed in a notch shape on a position corresponding to the metal electric connector linking part for separating the metal electric connector main bodies.

19. (cancelled)

20. (cancelled)

21. (amended) The electric connector assembled body of claim 18, wherein the metal electric connector linking part includes at least one groove of a wedge shape.

22. (amended) The electric connector assembled body of claim 18, wherein the plastic electric connector. separation part includes at least one groove of a wedge shape.

23. (amended) A board for fabricating an electronic circuit, comprising a plurality of electric connector insertion holes, wherein a step, for receiving and fixing electric connectors having protrusions, is formed on a boundary between an upper section and a lower section therein.

24. (cancelled)

25. (cancelled)

26. (amended) A board for fabricating an electronic circuit, comprising a plurality of electric connector insertion holes, each of which having symmetrical upper and lower sections and in the middle of which a step being protruded inward for fixing the electric connector fixing part protruded in a horizontal direction.

27. (amended) A board for fabricating an electronic circuit, comprising a plurality of electric connector insertion holes, the diameter of which becomes narrower until reaching the middle section thereof, so as that the electric connectors having protrusions can be caught in said middle section.

28. (amended) A board for fabricating an electronic circuit, comprising an upper layer and a lower layer, the upper layer comprising an elastic polymer material for receiving and fixing an electric connectors having a sharp end which can be surrounded and pressed by an elastic force of said elastic polymer.

29. The board of claim 28, wherein said lower layer is made of foamed polymer material.

30. (cancelled)

31. (amended) The board of claim 28, wherein the elastic polymer is elastic rubber.

32. (amended) The board of claim 28, wherein the elastic polymer is made of foamed polymer material.

33. (amended) The board of claim 28, wherein said lower layer is a rigid plate.

34. (amended) The board of claim 30, wherein the rigid plate is composed of Styrofoam.

35. (amended) The board of claim 30, wherein the rigid plate is composed of paper.
